(19) United States
(12) Patent Application Publication
(10) Pub. No.: US 2025/0315758 A1
(43) Pub. Date: Oct. 9, 2025

(54) INTELLIGENT WORKFLOW ORCHESTRATION

(71) Applicant: International Business Machines Corporation, Armonk, NY (US)

(72) Inventors: ZHI LI GUAN, Beijing (CN); Peng Hui Jiang, Beijing (CN); Jun Su, Beijing (CN); Kun Yang, Beijing (CN)

(21) Appl. No.: 18/625,731

(22) Filed: Apr. 3, 2024

(51) Int. Cl. G06Q 10/0631; G06F 40/284; H04L 51/02

(52) U.S. Cl. CPC G06Q 10/06316; G06F 40/284; H04L 51/02

(57) ABSTRACT

A processor set launches a chat bot to initiate a chat session with a user. The processor set runs a workflow including a plurality of tasks for performing via the processor. The processor set determines user role of the user. The processor set filters data resulting from running the workflow based on the user role of the user. The processor set presents via the chat bot on the chat session, the filtered data.

### BACKGROUND

The present application relates generally to computers and computer applications, and more particularly to automatic question-answering systems and workflow orchestration.

### BRIEF SUMMARY

The summary of the disclosure is given to aid understanding of a computer system and method of workflow orchestration, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A computer-implemented method, in some embodiments, includes launching, by a processor set, a chat bot to initiate a chat session with a user, responsive to receiving a request for work. The computer-implemented method also includes running, by the processor set, a workflow including at least one task associated with the work. The computer-implemented method also includes determining, by the processor set, a minimal user role needed for the at least one task. The computer-implemented method also includes filtering, by the processor set, based on the minimal user role and a user role of the user, data resulting from running the workflow. The computer-implemented method also includes presenting, by the processor set, via the chat bot on the chat session, the filtered data.

In some embodiments, a computer system includes a processor set. The computer system also includes a set of one or more computer-readable storage media. The computer system also includes program instructions, collectively stored in the set of one or more computer-readable storage media, for causing the processor set to perform the following computer operations: launch a chat bot to initiate a chat session with a user, responsive to receiving a request for work; run a workflow including at least one task associated with the work; determine a minimal user role needed for the at least one task; filter, based on the minimal user role and a user role of the user, data resulting from running the workflow; and present via the chat bot on the chat session, the filtered data.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement workflow orchestration in some embodiments.

FIG. 2 is a diagram illustrating system architecture for workflow orchestration in some embodiments.

FIG. 3 is a diagram illustrating historical data associated with workflow and different users in some embodiments.

FIG. 4 is a diagram illustrating interactive information associated with task and users in some embodiments.

FIG. 5 is a diagram illustrating analyzing collected data and detecting a minimized role for a task in some embodiments.

FIG. 6 is a diagram illustrating deciding or determining a needed role for current user in current task in some embodiments.

FIG. 7 illustrates answer generation in some embodiments.

FIG. 8 is a diagram illustrating a screen shot of a device on which a question-answering session is occurring in some embodiments.

FIG. 9 is a flow diagram illustrating a method that integrates question-answering and role-based decision support with workflow orchestration in some embodiments.

FIG. 10 is another flow diagram illustrating a method of workflow orchestration in some embodiments.

### DETAILED DESCRIPTION

A system including at least one computer processor and at least one memory device coupled with the at least one computer processor is also disclosed, where the at least one computer processor is configured to perform one or more methods described above. A computer program product is also disclosed that includes a computer readable storage medium having program instructions embodied therewith, where the program instructions are readable by a device to cause the device to perform one or more methods described above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as workflow orchestration algorithm code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

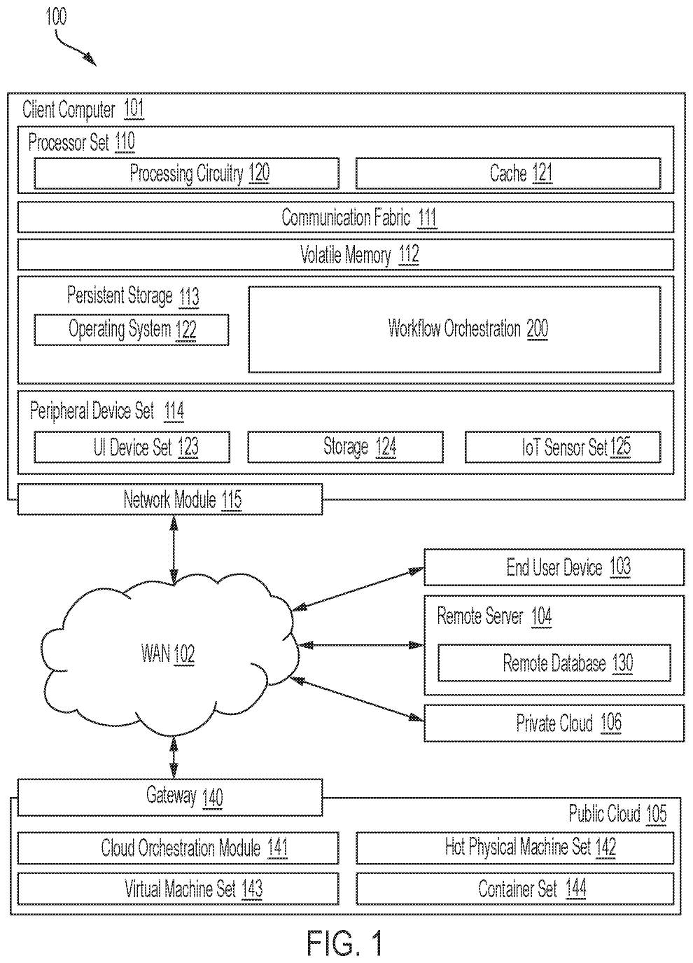

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Workflow refers to a set of tasks or a sequence of tasks to be processed or completed, for example, for accomplishing a goal or a job. A workflow application is a computer-implemented application that automates that process, for example, completing the set of tasks or the sequence of tasks. A workflow application may automate a specific task within the set or entire set. For example, a user creates workflow applications to improve productivity. In some instances, workflow applications coordinate work between tasks performed by humans and automated tasks to improve daily business operations. A workflow may involve several personas and system tasks to complete a full job. Also, during the workflow processing, for data protection, different roles involved in the workflow may access only specific parts of the data according to different permissions.

Question answering (QA) is a computer science discipline within the fields of information retrieval and natural language processing (NLP) that is concerned with building systems that automatically answer questions that are posed by humans in a natural language. QA systems provide human-computer interactions for providing desired solutions.

In some embodiments, a system and/or method disclosed herein integrate workflow processing with QA system, and achieves intelligent workflow orchestration within QA system. For example, in responding to a user question, QA system may run a workflow application. The QA system incorporate user role and data privacy in running the workflow application. For instance, user requested data in a specific workflow task considers the permission or role for that specific workflow task, the user's permission or role, whether the user is qualified to run the workflow task, the type of data that can be included in an answer provided to the user according to the user's permission or role.

In some embodiments, the system and/or method intelligently orchestrate workflow with role-based decision support and adaptive QA integration. In some embodiments, a system (by way of example) collects historical data in workflow for each task along with different users. This creates a knowledge base. The system also collects interactive information in each task for each user. The system analyzes collected data and detects the minimized role for each task. The system accepts a question and answer request in a QA system for one user to process one task in workflow system. The system check the needed role for this user in current task along with other users in historical data. The system checks the needed role for this user using upstream and downstream task-based role information. The system decides the needed role for a current user in current task. The system decides an answer for a current user in a current task in a QA system. The system generates an answer with role-based answer, for example, considers the user role in generating the answer.

The system and/or method disclosed herein can be integrated with a generative artificial intelligence (AI) platform. In some embodiments, natural language processing (NLP) capabilities can be employed for text summarization, keyword extraction, and semantic analysis during a running a workflow task. Machine learning can be used for training and deploying machine learning models for use in running a workflow task. The system and/or method can also be used in building and managing AI models as a workflow. The system and/or method may enhance the user experience by protecting sensitive data by adopting role information analysis and/or providing fine grained information protection for workflow capability. The system and/or method provides for intelligent workflow orchestration, for example, by incorporating QA system or methodology that considers user roles and permissions.

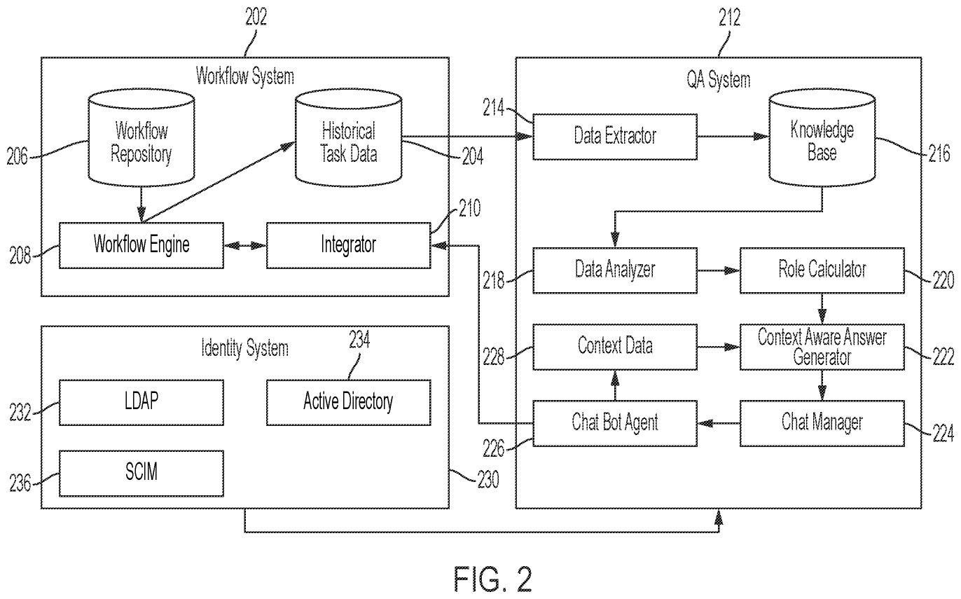

FIG. 2 is a diagram illustrating system architecture for workflow orchestration in some embodiments. The components shown are computer-implemented components, for example, computer functionality, functions, modules, which can be implemented on computer environment, e.g., shown in FIG. 1. For example, one or more memory devices and/or storage devices can store data and information involved in the components, a processor set can run one or more operations or functions involved in the components. Workflow system (or module or functionality) 202 includes historical task data 204, workflow repository 206, workflow engine 208 and integrator 210. Workflow repository 206 includes workflows model data, which represents how a workflow is defined . . . . Historical task data 204 includes information about tasks, for example, of which workflow a task is an instance, who created the task, which one or more users or groups (e.g., organization department) have access to the task, who is working on the task, and/or other information about the task. Information can include task name, users who have worked on the task, and/or others. Workflow engine 208 performs tasks of a workflow specified in workflow repository 206 and historical task data 204. Integrator 210 interfaces or communicates with QA system 212. Integrator 210 integrates QA chat bot agent 226 in running a workflow such that the user can obtain an answer to a question, e.g., any time the user runs a task. Integrator 210 can also receive one or more requests from QA system 212 (or module or functionality) to trigger corresponding workflow to achieve intelligent workflow orchestration.

QA system 212 includes data extractor 214 that extracts or receives information about historical tasks from the workflow system's historical task data 204 and builds knowledge base 216. Knowledge base 216 stores information about tasks extracted from historical task data 204, the users who worked on the tasks and those users' roles and permissions (permission levels). Permissions or permission levels refer to authorizations or authorization levels, e.g., what the user roles are authorized or permitted to do. Data analyzer 218 analyzes information of the knowledge base 216 to obtain the minimal role required for a task. A minimal role refers to a role having at least the required permission level for performing the task. Role calculator 220 based on analysis performed by the data analyzer 218 determines user roles (e.g., those that have required authorization levels) needed for performing the tasks extracted from the historical task data 204. Chat manager 224 launches chat bot agent 226 that triggers or initiates a chat session with a user. In responding to the user's query, chat bot agent 226 may launch or trigger a workflow via the integrator 210. Context data 228 related to a chat session being performed with the chat bot agent 226 is received by context aware answer generator 222. Context aware answer generator 222 generates a response to the user's query appropriate for the user role this user has. QA system 212 in providing an answer to the user's query may use techniques such as natural language processing (NLP), for example, to interpret and/or parse user queries (e.g., into tokens for understanding the query), and/or machine learning techniques, and/or other techniques. Chat manager 224 communicates the response to the chat bot agent 226 to present the response to the user via the chat session. QA system also uses identity system 230, which may include Lightweight Directory Access Protocol (LDAP) 232, active directory 234 and System for Cross-domain Identity Management (SCIM) 236 to obtain information about the users. For example, QA system 212 may use a third-party identity system such that acts as the role of managing user/group information and provides authentication/authorization function to QA system 212. In some embodiments, identity system 230 can also provide necessary user/group information to the QA system 212, so the QA system 212 can provide context aware answers to end users.

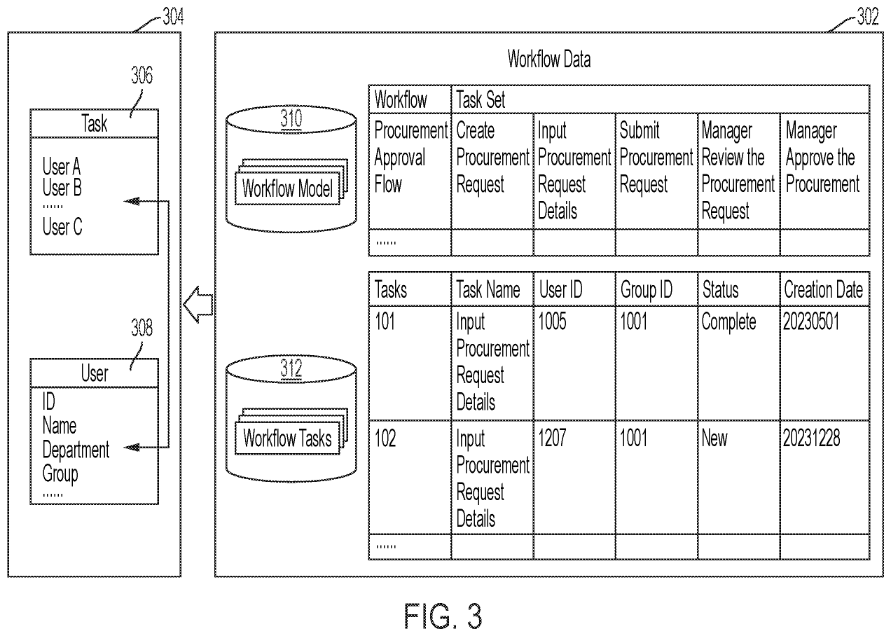

FIG. 3 is a diagram illustrating historical data associated with workflow and different users in some embodiments. For example, historical data (shown in FIG. 2 at 204) can be collected, examples of which are shown can include data and data structure shown at 302 and 304. For example, historical data can include a list of users who have worked on a task as shown at 306. Historical data can also include information about those users as shown at 308. Workflow data 302 can include workflow model 310 or data structure that stores information about a workflow and a set of tasks involved in that workflow. For example, workflow “Procurement approval flow” has a task set that includes “Create procurement request; Input procurement request details; Submit procurement request; Manager review the procurement request; Manager approve the procurement.” A model, for example, a workflow model represents how a workflow is defined, e.g., a purchase request workflow includes three steps 1) submit request, 2) manager reviews and approves/rejects, 3) user gets review result. Workflow tasks data structure 312. Model represents how a workflow is defined, e.g., a purchase request workflow includes three steps 1) submit request, 2) manager review and approve/reject, 3) user get review result. While a workflow task is a real instance of above definition, e.g. user John created a book purchase request. stores information about individual tasks associated with workflows included in the workflow model 310. A workflow task is a real instance of a task defined in a workflow model, e.g. user John created a book purchase request. For example, tasks are triggered when a corresponding workflow process begins. Each task has a user and/or group information who ran the task. Information shown at 304 can be extracted from information shown in 302. For example, workflow data 302 includes information about defined workflows and tasks. Functionality at 304 extracts needed data from workflow data 304 that can help generate context aware answer.

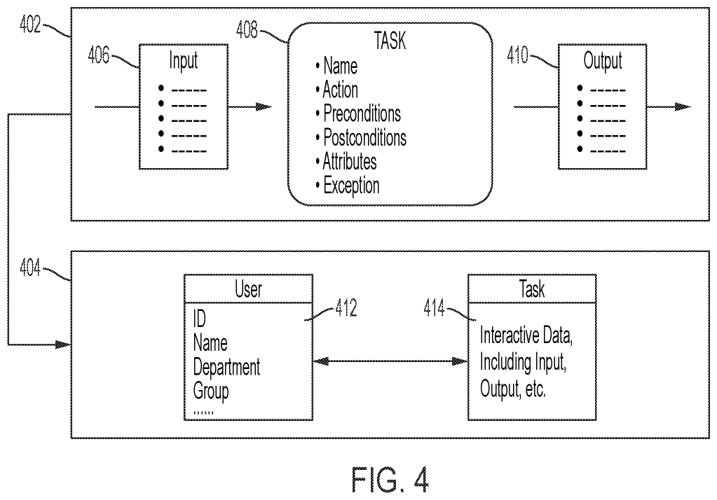

FIG. 4 is a diagram illustrating interactive information associated with task and users in some embodiments. For each user performing a task, interactions between the user and a computer performing the task are collected and stored. In some embodiments, the interactive information is unique for each of users, e.g., a specific user can input and access specific data based on the role of the user and permission the user has. As shown at 402, a task 408 may have inputs 406 that are input to the task 408, for example, for the task 408 to use during its processing or performance. A task 408 also may have outputs 408 that are generated as a result of processing or performing the task. A task 408 can have a name, action, preconditions, postconditions, attributes and exceptions. At 404, information about a user and user's interaction with a processor set that is performing the task are shown. User information 412 can be linked with task information 414 that the user is running via a processor set. User information 412 can include identifier, name, department, group, and/or others. Task information 414 can include interactive data, e.g., information that is communicated between the user and task (a processor that performs the task) that can include input data, output data, and/or others. Data about the task 402 and user and interactive information 404 can be collected and stored.

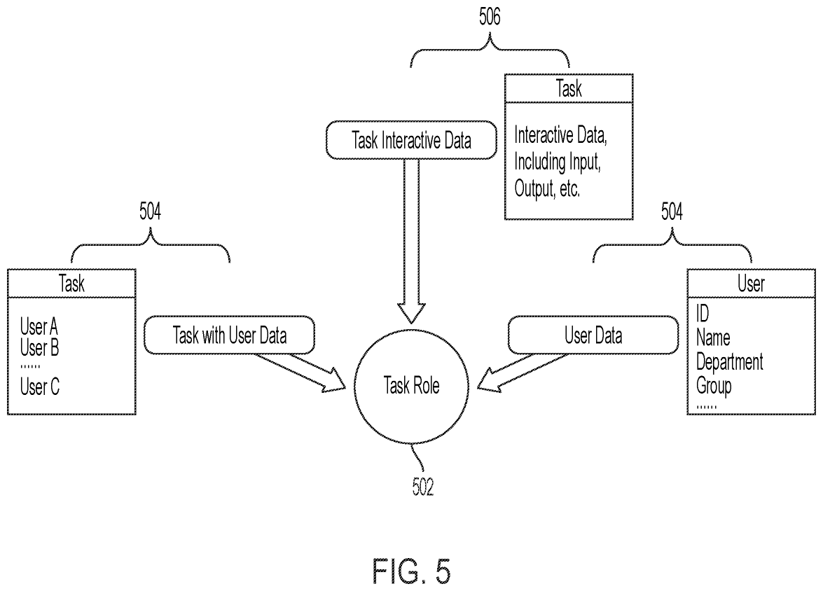

FIG. 5 is a diagram illustrating analyzing collected data and detecting a minimized role for a task in some embodiments. For example, a processor analyzes the collected data and detects a minimized role for each task in a workflow. The minimized role refers to a user role that has at least a set of permissions or at least a permission level for performing a given task. A task role 502 is determined using task with user data 504 (e.g., also shown at 306 in FIG. 3), task interactive data 506 (e.g., shown at 414 in FIG. 4), and user data 508 (e.g., also shown at 308 in FIG. 3). For example, common characteristics can be extracted from historical data such as users who worked on the task, and determine what roles they had when working on the task to detect the minimized role. User data can also be used to detect what type of data access the users had when working on the task to detect the minimized role.

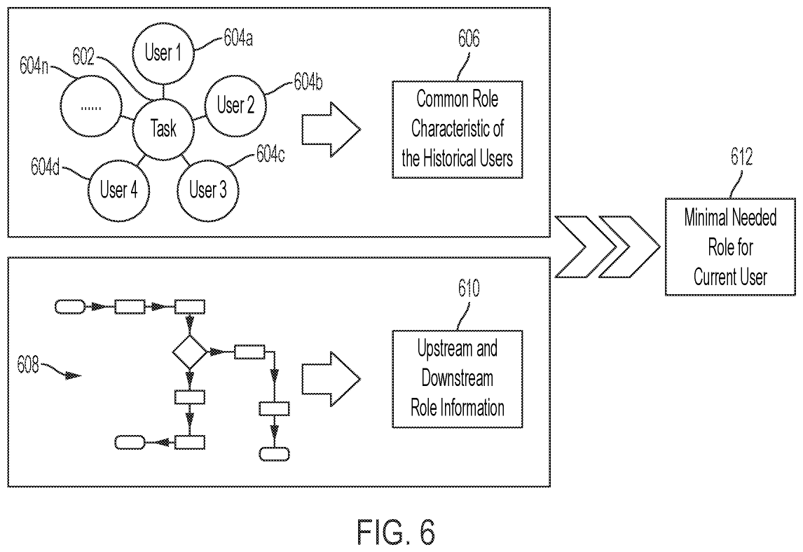

FIG. 6 is a diagram illustrating deciding or determining a needed role for current user in current task in some embodiments. A task 602 can involve multiple users 604a, 604b, 604c, 604d, 604n. Common characteristics of users who worked on that task (e.g., current task) can be analyzed, collected and/or stored as shown at 606. Upstream and downstream role information 610 can be analyzed and/or collected. Upstream information include information associated with prior processing performed prior to the task performance (e.g., current task) in a workflow 608. Downstream information include information associated with subsequent processing performed after the task performance (e.g., current task) in the workflow 608. Based on the common characteristics of user 606 and upstream and downstream role information 610, minimal needed role for a current user 612 performing a current task can be determined. For example, a task input data structure is [order id], the output data structure is [order id, order amount, order date, customer name, customer contact, customer location]. If an upper manager runs the task, based on the internal logic, the full data are returned, e.g., [order id, order amount, order date, customer name, customer contact, customer location]. If a manager having less authority than the upper manager runs the task, some fields are not returned, e.g., only [order id, order amount, order date, customer name, customer location] is returned as task output. If an employee having less authority than the manager runs the task, less data are return, e.g., only [order id, order amount, order date]. Based on combining the roles, e.g., information each role was able to receive as task output and historical data a user can access, a minimal level of role the user would need can be determined.

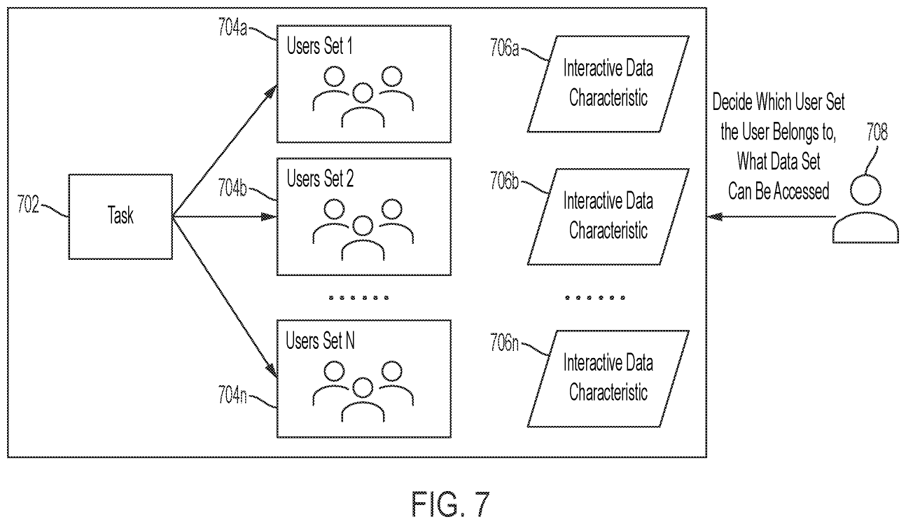

FIG. 7 illustrates answer generation in some embodiments. For example, a processor generates an answer based on current user and the role information of the current task. When the minimal role is met, a QA system generates an answer based on a user's real role. With a different role, the returned data may be different. Returned data can be generated from a historical workflow task interactive information. A task 702 may have had different set of users 704a, 704b, 704n that worked on or performed the task 702. Interactive data characteristics 706a, 706b, 706n of each of the different set of users 704a, 704b, 704n can be obtained. Based on the interactive data characteristics 706a, 706b, 706n, a processor set determines, to which user set a current user 708 belongs, and what data set the current user 708 can access.

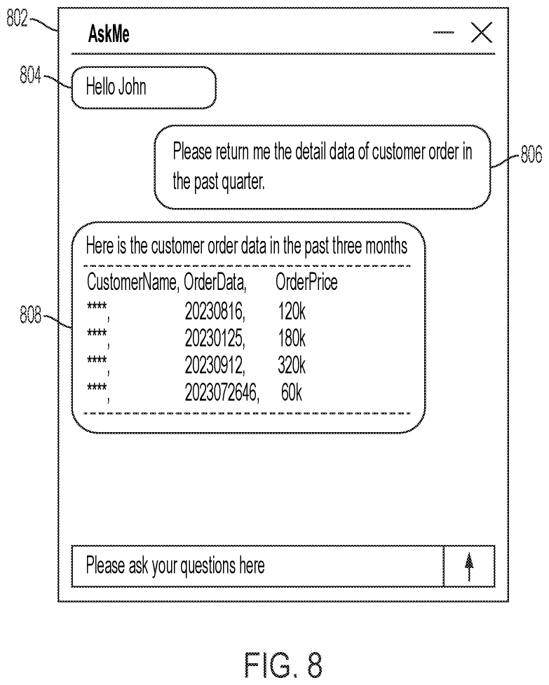

FIG. 8 is a diagram illustrating a screen shot of a device on which a question-answering session is occurring in some embodiments. A screen shot 802 shows an interaction between a user (e.g., here named “John”) and a processor set that may be performing the question-answering session (for example, a chatbot). The processor set greets the user at 804. The user presents a question or a request at 806, e.g., to return details of customer order in certain time period. In the background, the processor set (e.g., running a chatbot) starts a workflow that should be performed in order to provide the answer to the user's question or request. At 808, the processor set running a question-answering (QA) system or module for conducting the question-answering session with the user presents the results requested by the user. For example, in some embodiments, the QA system analyzes the task historical data including task and user relationship and users' task interactive information (e.g., shown in FIG. 3 and FIG. 4). In some embodiments, the QA system returns only part of the full data based on the user's role. In this example, customer names are hidden, e.g., because in this example user does not have the role or permission for viewing that information. For another user who has the necessary role and permission to view customer names, the customer names can be returned. In some embodiments, providing an answer may include triggering or redirecting to another workflow. For example, the chatbot may present a link on the screen, via which a user may launch another workflow.

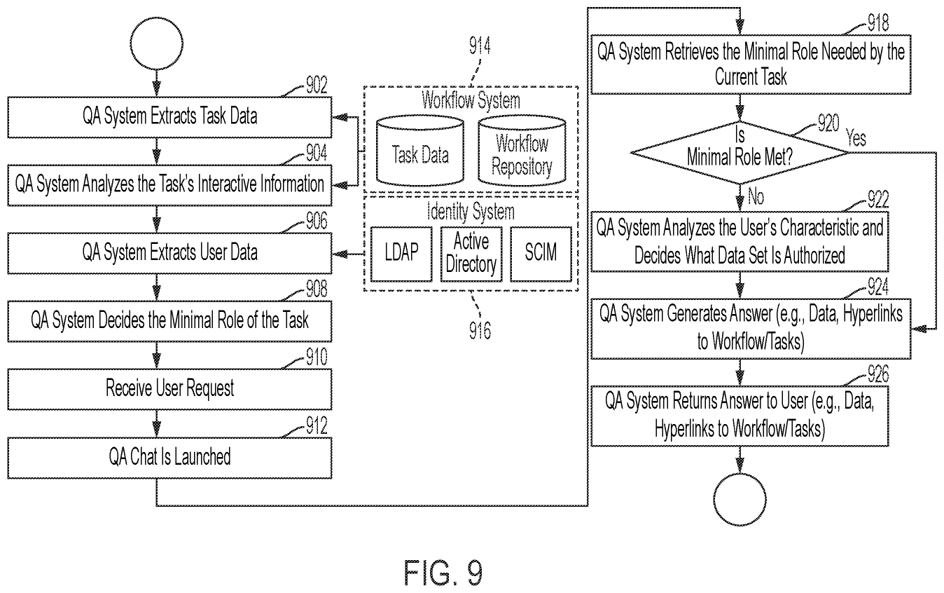

FIG. 9 is a flow diagram illustrating a method that integrates question-answering and role-based decision support with workflow orchestration in some embodiments. A computer, for example, having a processor set may perform or implement the method. At 902, question-answering (QA) system or module extracts task data. To build a full knowledge base, the QA system extracts all the task data. In some embodiments, a user may configure or customize a range such as data range to extract a range of task data. Task data include information shown in FIG. 3, e.g., task name, user identifier of user who worked on the task, and/or others. In some embodiments, the processing at 902, which extracts data from the workflow system, may run continuously or continually, for example, to receive up-to-date data in building a knowledge base. At 904, QA system analyzes the task's interactive information. Task's interactive information include information described with reference to FIG. 4. For example, QA system accesses workflow system 914 or module that include information or data about tasks (task data) and workflows (e.g., workflow repository or workflow data shown at 302 in FIG. 3).

At 906, QA system extracts user data such as those shown in FIG. 3 at 308, and also shown in FIG. 4 at 412. User data includes information about users. For example, user data can be obtained from an identity system 916 which may store information about users, e.g., tasks the users worked on, user roles, permissions, and/or other information. Identity system 916 may include Lightweight Directory Access Protocol (LDAP), active directory and System for Cross-domain Identity Management (SCIM), which can manage user identity information. In some embodiments, the QA system extracts data for all active users. Active users are those involved in any tasks, for example, as a creator, owner, or a member of a group related to a task.

At 908, QA system determines or decides the minimal role of the task. For example, each of all users who worked on, or are related with, the task has a user role specified. The intersection of all the users' roles is determined to be the minimal role needed to run the task. Minimal role refers to a user role that has at least a required permission level needed to run or perform a given task.

At 910, a request is received, e.g., a user submits a request. For example, a user can submit a vacation request in a company's system that handles such requests. Such request initiates or triggers running of a vacation request workflow.

At 912, QA chat is launched. For example, in response to receiving the request, the integrator (e.g., 2, 210) may launch the chat bot agent (e.g., 226) that accepts the request, which also triggers related backend workflow to run and return a reply or answer to the request. The request, thus may, trigger running of one or more tasks defined in a workflow.

At 918, QA system retrieves the minimal role needed by the current task. For example, minimal roles of tasks were determined at 908 and stored in knowledge base (e.g., FIG. 2, 216). At 918, QA system retrieves the minimal role for the current task (e.g., one or more tasks involved in the workflow related to the request).

At 920, it is determined whether the minimal role is met. For example, it is determined whether the user has a user role that has at least the required permission level for tasks or for accessing data associated with tasks, which may be run during providing an answer or reply to the request. For example, the user's request may initiate a task and also a QA chat. During the QA chat, the user may ask a question (e.g., “return orders in the past quarter”). In response, the QA chat may launch a backend workflow, which runs tasks and returns results. If the user has a role with proper authorization or permission level for the task or accessing the results of the task, the QA chat presents the results to the user. If the user does not have the role with proper authorization or permission level, the QA chat may return a notification such as “You are not authorized to access the orders in the past quarter”. In some embodiments, if the minimal role that is needed is not met, at 922, QA system analyzes the user's characteristic or permission level, and decides what data set the user is authorized to access and/or view, and proceeds to 924. If, at 920, it is determined that the minimal role is met, at 924, QA system generates an answer. For example, at 924, based on the user role, data that can be presented to the user as part of an answer is determined. In some embodiments, an answer may also include a workflow and/or one or more tasks in the workflow. For example, a returned answer may be a hyperlink of a workflow. By way of an example, a user may ask, “I would like to submit a purchase request.” The QA system may return a hyperlink, which when clicked, triggers running of a purchase request workflow or workflow task defined in such workflow. In some embodiments, an answer to a user's request (e.g., “how to submit a seat change request”) may return a hyperlink to a corresponding workflow, which when clicked, initiates or triggers a workflow that shows how to submit a seat change, and even initiate the seat change process.

At 926, QA system returns the answer to user's question or request, example of which is shown in FIG. 8 at 808. In some embodiments, answer includes data, and/or links or hyperlinks that trigger additional workflow or workflow tasks.

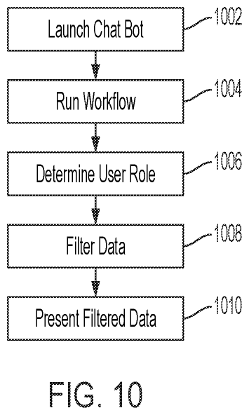

FIG. 10 is another flow diagram illustrating a method of workflow orchestration in some embodiments. The method can be implemented and/or run on one or more computers with at least one processor set, for example, in a computing environment shown in FIG. 1. At 1002, the method includes launching, by a processor set, a chat bot to initiate a chat session with a user. In some embodiments, the processor set, responsive to receiving a request for work (e.g., as described above with reference to FIG. 9), initiates or launches the chat bot.

At 1004, the method includes running, by the processor set, a workflow including at least one task defined in the workflow associated with the work. For example, as described above, the workflow is run for providing an answer to the user's request for work. The answer may be determined based on the results of running the workflow.

At 1006, the method includes determining, by the processor set, a minimal user role needed for at least one task in the workflow that is being run. For example, as described above, minimal user role can be determined using historical data associated with the task and users who worked on the task. For example, a lowest level of user role of a user who worked on the task can be determined as the minimal user role.

At 1008, the method includes filtering, by the processor set, based on the minimal user role and a user role of the user, data resulting from running the workflow. For example, in providing an answer to the user during the chat session, the processor set analyzes the results from running the workflow, and may hide or mask some data, which the user may not have the permission to access. For example, such filtering is performed based on the user role having less privileges than the minimal user role. In some embodiments, filtering includes masking information in the data that is impermissible to the user role. In some embodiments, filtering includes hiding information in the data that is impermissible to the user role.

At 1010, the method includes presenting, by the processor set, via the chat bot on the chat session, the filtered data. As described above, in some embodiments, filtering and presenting is performed during the chat session that is automatically launched.

In some embodiments, the workflow can include a task that involves interaction with another user. In some embodiment, the workflow is triggered to run based on interpreting a natural language query from a user in the chat session, using a natural language processing technique that parses the natural language query into tokens for understanding by the processor set.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in some embodiments” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
launching, by a processor set, a chat bot to initiate a chat session with a user, responsive to receiving a request for work;
running, by the processor set, a workflow including at least one task associated with the work;
determining, by the processor set, a minimal user role needed for the at least one task;
filtering, by the processor set, based on the minimal user role and a user role of the user, data resulting from running the workflow; and
presenting, by the processor set, via the chat bot on the chat session, the filtered data.

2. The computer-implemented method of claim 1, wherein the workflow includes a task that involves interacting with another user.

3. The computer-implemented method of claim 1, wherein the minimal user role is determined based on historical data associated with the workflow and users who worked on the at least one task defined in the workflow.

4. The computer-implemented method of claim 1, wherein the filtering is performed based on the user role having less privileges than the minimal user role.

5. The computer-implemented method of claim 1, wherein the workflow is triggered to run based on interpreting a natural language query from a user in the chat session, using a natural language processing technique that parses the natural language query into tokens for understanding by the processor set.

6. The computer-implemented method of claim 1, wherein the filtering includes masking information in the data that is impermissible to the user role.

7. The computer-implemented method of claim 1, wherein the filtering includes hiding information in the data that is impermissible to the user role.

8. A computer program product comprising:
a set of one or more computer-readable storage media;
program instructions, collectively stored in the set of one or more storage media, for causing a processor set to perform the following computer operations:
launch a chat bot to initiate a chat session with a user, responsive to receiving a request for work;
run a workflow including at least one task associated with the work;
determine a minimal user role needed for the at least one task;
filter, based on the minimal user role and a user role of the user, data resulting from running the workflow; and
present via the chat bot on the chat session, the filtered data.

9. The computer program product of claim 8, wherein the workflow includes a task that involves interacting with another user.

10. The computer program product of claim 8, wherein the minimal user role is determined based on historical data associated with the workflow and users who worked on the at least one task defined in the workflow.

11. The computer program product of claim 8, wherein the data is filtered based on the user role having less privileges than the minimal user role.

12. The computer program product of claim 8, wherein the workflow is triggered to run based on interpreting a natural language query from a user in the chat session, using a natural language processing technique that parses the natural language query into tokens for understanding by the processor set.

13. The computer program product of claim 8, wherein the data is filtered by masking information in the data that is impermissible to the user role.

14. The computer program product of claim 8, wherein the data is filtered by hiding information in the data that is impermissible to the user role.

15. A computer system comprising:
a processor set;
a set of one or more computer-readable storage media;
program instructions, collectively stored in the set of one or more computer-readable storage media, for causing the processor set to perform the following computer operations:
launch a chat bot to initiate a chat session with a user, responsive to receiving a request for work;
run a workflow including at least one task associated with the work;
determine a minimal user role needed for the at least one task;
filter, based on the minimal user role and a user role of the user, data resulting from running the workflow; and
present via the chat bot on the chat session, the filtered data.

16. The system of claim 15, wherein the workflow includes a task that involves interacting with another user.

17. The system of claim 15, wherein the minimal user role is determined based on historical data associated with the workflow and users who worked on the at least one task defined in the workflow.

18. The system of claim 15, wherein the data is filtered based on the user role having less privileges than the minimal user role.

19. The system of claim 15, wherein the workflow is triggered to run based on interpreting a natural language query from a user in the chat session, using a natural language processing technique that parses the natural language query into tokens for understanding by the processor set.

20. The system of claim 15, wherein the data is filtered by masking information in the data that is impermissible to the user role.
